(19) United States
(12) Patent Application Publication
(10) Pub. No.: US 2012/0154712 A1
(43) Pub. Date: Jun. 21, 2012

(54) LIQUID CRYSTAL DISPLAY DEVICE AND BACKLIGHT MODULE THEREOF

(76) Inventors: Shang-Wen Yu, Yilan County (TW); Chin-Yung Lin, Taoyuan County (TW)

(21) Appl. No.: 13/044,549

(22) Filed: Mar. 10, 2011

(30) Foreign Application Priority Data
Dec. 16, 2010 (TW) 099144182

(51) Int. Cl. G02F 1/13357; F21V 7/22

(52) U.S. Cl. 349/64; 362/611; 349/62

(57) ABSTRACT

A liquid crystal display (LCD) device includes an LCD panel, a backlight module and an anti-reflective layer. The backlight module further includes a light source for providing lights, a light guide plate having a light-emitting surface and a lower surface opposite to the light-emitting surface, and a first prism layer and a second prism layer positioned on a side of the light-emitting surface. The anti-reflective layer is positioned between the first prism layer and the second prism layer, or is positioned between the first prism layer and the LCD panel.

### BACKGROUND OF THE INVENTION

1. Field of the Invention

The present invention is related to a liquid crystal display (LCD) device and a backlight module thereof, and more particularly, to a LCD device and a backlight module that is able to reduce reflective Moire.

2. Description of the Prior Art

With the progress of flat display device, the LCD devices have gradually replaced cathode ray tube (CRT) display devices and widely used in electronic products such as mobile phones, notebook computers, digital cameras, projector and so on. The LCD device essentially includes an LCD panel and a backlight module for providing backlight to the LCD panel.

Please refer to FIG. 1, which is a schematic drawing of a conventional LCD device. As shown in FIG. 1, the conventional LCD device 1 includes an edge-lighting type backlight module 10 and an LCD panel 12. The LCD panel 12 includes an upper polarizer 120, a color filter substrate 122, a thin film transistor (TFT) array substrate 124, and a liquid crystal (LC) layer 126 sandwiched between the TFT array substrate 124 and the color filter substrate 122, and a lower polarizer 128. And the backlight module 10 includes a light source 100, a light guide plate 102, a diffuser 104, a first prism sheet (also known as lenticular sheet) 106a, and a second prism sheet 106b. The diffuser 104 is used to make a uniform dispersion of light emitted from the light guide plate 102. However, the diffuser 104 worsens light directionality of the light emitted from the backlight module 10. Accordingly, the prior art develops the prism sheets 106a/106b on the diffuser 104 for gathering light beams. In detail, by light refraction and light reflection occurred at the prism layers, direction of the emitted light is adjusted and the brightness of the backlight module 10 is improved.

It is well-known to those skilled in the art that first prism sheet 106a and the second prism sheet 106b are formed by polyester or polycarbonate. And a surface of the first and second prism sheet 106a/106b includes a plurality of prism or half-cylinder stripe array for converging light. As shown in FIG. 1, the prism strip array of the first prism sheet 106a is arranged along a first direction d1, and the prism strip array of the second prism sheet 106b is arranged along a second direction d2. The first direction d1 is perpendicular to the second direction d2. Conventionally, the brightness of the backlight module 10 is improved up to 60%-100% when the two prism sheets are applied.

Please refer to FIG. 2 and FIG. 1, wherein FIG. 2 is a schematic drawing illustrating optical paths of the light between the first prism sheet 106a and the second prism sheet 106b. As shown in FIG. 2, the incident light L1 is emitted from the light source 100, and passes through the light guide plate 102, the diffuser 104, and the first prism sheet 106a. When the incident light L1 is emitted from the first prism sheet 106a, a portion of the incident light L1 is reflected at G₁, which is at the interface between the first prism sheet 106a and the air, and serves as a reflected light R1. And a portion of the incident light L1 is refracted at G₁ but reflected back at H₁ which is at the interface between the even surface of the second prism sheet 106b and air, and enters the first prism sheet 106a at F₁, which is at the interface between they first prism sheet 106a and air, and serves as a reflected light R1′. As shown in FIG. 2, interference is always found between the reflected light R1 and the reflected light R1′. In other words, interference such as Newton ring is occurred at the prism structure of the first prism sheet 106a and the even surface of the second prism sheet 106b. Furthermore, Newton ring not only occurs between the first and second prism sheets 106a/106b, but also occurs between the second prism sheet 106b and the lower polarizer 128, even between the first prism sheet 106a and the diffuser 104.

As mentioned above, since the first prism sheet 106a and the second prism sheet 106b possesses high regularity, reflective Moire or Newton ring are easily occurred between the second prism sheet 106b and the lower polarizer 128, between the first prism sheet 106a and the second prism sheet 106b, and between the first prism sheet 106a and the diffuser 104 due to the interference between the first time refraction and the second time refraction. Consequently, plane light source provided by the backlight module 10 is not desirably uniform.

### SUMMARY OF THE INVENTION

Therefore the present invention provides an LCD device and a backlight module thereof that is able to reduce reflective Moire and Newton ring.

According to a first aspect of the present invention, a backlight module is provided. The back light module includes a light source providing lights, a light guide plate having a light-emitting surface and a lower surface opposite to the light-emitting surface, a first prism layer positioned on a side corresponding to the light-emitting surface of the light guide plate, a second prism layer, and an anti-reflective layer positioned between the first prism layer and the second prism layer.

According to a second aspect of the present invention, an LCD device is provided. The LCD device includes an LCD panel, a backlight module and an anti-reflective layer. The backlight module includes a light source for providing lights, a light guide plate having a light-emitting surface and a lower surface opposite to the light-emitting surface, and a first prism layer positioned on a side corresponding to the light-emitting surface of the light guide plate. The anti-reflective layer is positioned between the first prism layer and the LCD panel.

According to the LCD device and the backlight module provided by the present invention, the anti-reflective layer is positioned between the prism layers or between the prism layer and an adjacent even surface. Therefore reflection between the prism layer and the adjacent even surface is reduced and consequently reflective Moire and Newton ring are avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a conventional LCD device.

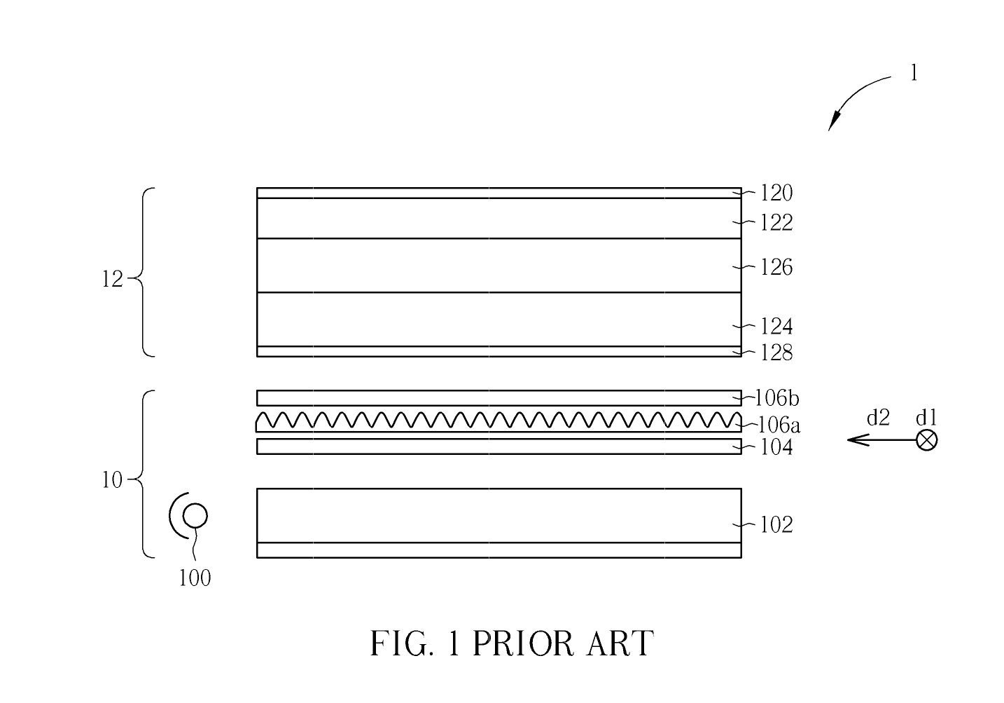

FIG. 2 is a schematic drawing illustrating optical paths of the light between the first prism sheet and the second prism sheet of the conventional LCD device.

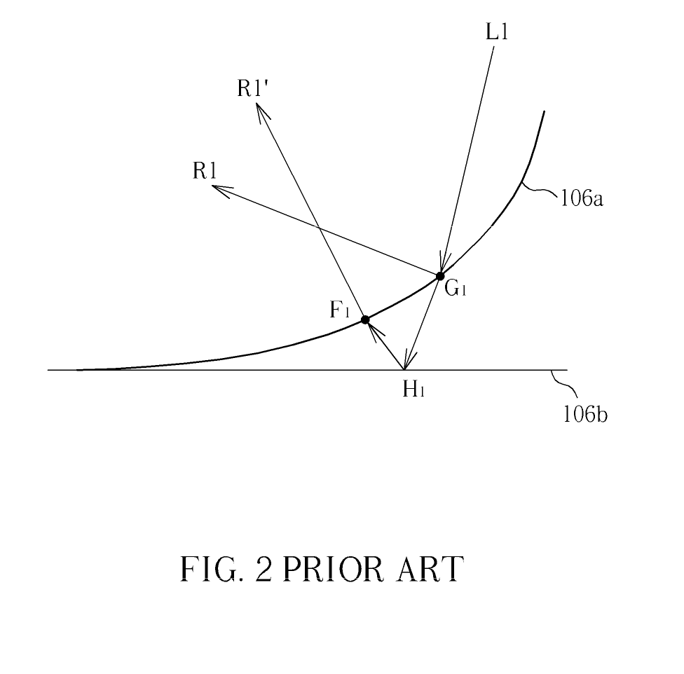

FIG. 3 is a schematic drawing of a LCD device provided by a first preferred embodiment of the present invention.

FIG. 4 is a schematic drawing illustrating optical paths of the light according to the first preferred embodiment and the third preferred embodiment.

FIG. 5 is a schematic drawing of a LCD device provided by a second preferred embodiment of the present invention.

FIG. 6 is a schematic drawing illustrating optical paths of the light according to the second preferred embodiment and the third preferred embodiment.

FIG. 7 is a schematic drawing of a LCD device provided by a third preferred embodiment of the present invention.

FIG. 8 is a schematic drawing of a LCD device provided by a fourth preferred embodiment of the present invention.

FIG. 9 is a schematic drawing of a LCD device provided by a fifth preferred embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

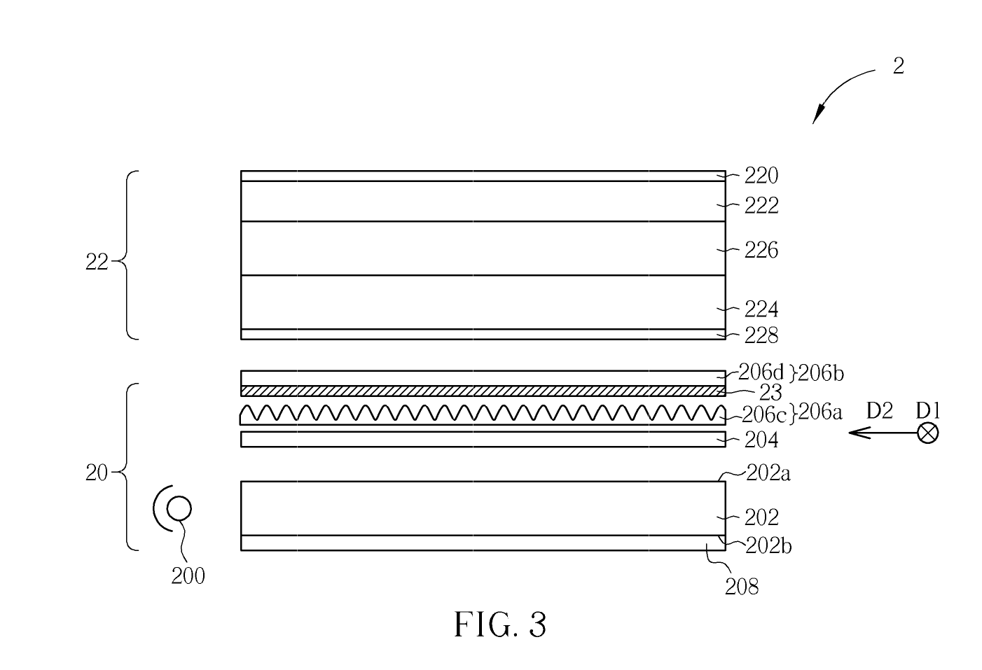

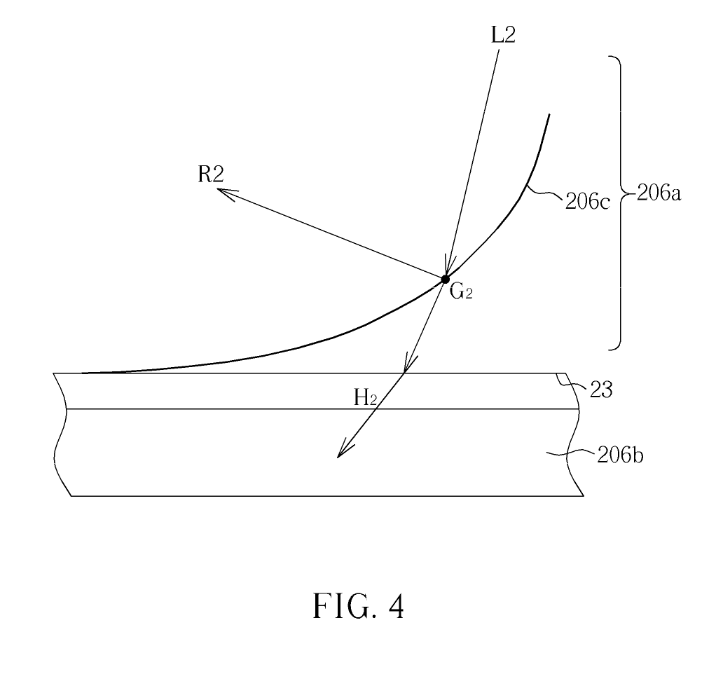

Please refer to FIGS. 3-4, wherein FIG. 3 is a schematic drawing of a LCD device provided by a first preferred embodiment of the present invention, and FIG. 4 is a schematic drawing illustrating optical paths of the light according to the first preferred embodiment. As shown in FIG. 3, the LCD device 2 provided by the preferred embodiment includes a backlight module 20 and an LCD panel 22. The LCD panel 22 includes an upper polarizer 220, a color filter substrate 222, a TFT array substrate 224, an LC layer 226 sandwiched between the color filter substrate 222 and the TFT array substrate 224, and a lower polarizer 228. As shown in FIG. 3, the upper polarizer 220 is positioned on a surface of the color filter substrate 222 that is opposite to the TFT array substrate 224, and the lower polarizer 228 is positioned on a surface of the TFT array substrate 224 that is opposite to the color filter substrate 222. Since the elements of the LCD panel 22 are well-known to those skilled in the art, those details are omitted herein in the interest of brevity.

Please refer to FIG. 3 again. The backlight module 20 provided by the preferred embodiment includes a light source 200 and a light guide plate 202, and the light guide plate 202 includes a light-emitting surface 202a and a lower surface 202b opposite to the light-emitting surface 202a. It is noteworthy that the backlight module 20 provided by the preferred embodiment is an edge-lighting type backlight module, therefore the light source 200 is positioned on a side perpendicular to the light-emitting surface 202a of the light guide plate 202. However, the backlight module 20 of the preferred embodiment can be a bottom light type backlight module when the size of the LCD panel is increased, and the light source 200 is equipped on a side corresponding to the lower surface 202b of the light guide plate 202. The light source 200 includes light emitting device having high brightness and long lifespan such as a cold cathode fluorescent lamp (CCFL), a hot cathode fluorescent lamp (HCFL), or light-emitting diode (LED).

Please still refer to FIG. 3. The backlight module 20 provided by the preferred embodiment further includes a reflector 208 positioned on the lower surface 202b of the light guide plate 202. The reflector 208 is used to reflect light from the lower surface 202b back to the light guide plate 202. Accordingly, light utilization efficiency is improved. Those skilled in the art would easily realize when the backlight module 20 is a bottom light type backlight module, the reflector 208 is positioned on the sidewalls and bottoms of a lamp box (not shown) for reflecting light back into the light guide plate 202. Furthermore, the backlight module 20 of the preferred embodiment includes a diffuser 204 positioned on the light-emitting surface 202a of the light guide plate 202. When the lights pass through the diffuser 204, refraction, reflection and scattering are occurred. Consequently, a plane light source having uniform dispersion is obtained by applying the diffuser 204.

Please still refer to FIG. 3. The backlight module 20 of the preferred embodiment further includes a first prism layer 206a and a second prism layer 206b. The first prism layer 206a is positioned on a light-emitting surface of the diffuser 204, and the second prism layer 206b is positioned between the first prism layer 206a and the lower polarizer 228. According to the preferred embodiment, the first prism layer 206a includes a plurality of prism structures 206c such as a plurality of prism or half-cylinder columns arranged along a first direction D1, and the second prism layer 206b includes a plurality of prism structure 206d such as a plurality of prism or half-cylinder columns arranged along a second direction D2. The first direction is substantially perpendicular to the second direction D2. However, it will be appreciated by those of ordinate skill in the art that the prism structures 206c of the first prism layer 206a, the prism structures 206d of the second prism layer 206b, the first direction D1 and the second direction D2 can be adjusted if required and not limited to the above mentioned disclosure. As mentioned above, the directionality of the light emitted from the diffuser 204 is inferior and thus the first prism layer 206a and the second prism layer 206b are provided to adjust the direction of the emitted light. Consequently, brightness and light utilization efficiency of the backlight module 20 are both improved according to the preferred embodiment.

Please simultaneously refer to FIG. 3 and FIG. 4. More important, the preferred embodiment further includes an anti-reflective layer 23 between the first prism layer 206a and the second prism layer 206b. The anti-reflective layer 23 is preferably an anti-reflective coating formed on the even light-incident surface of the second prism layer 206b. When the light is emitted from the first prism layer 206a, a portion of the incident light L2 is reflected at G₂, which is at the interface between the prism structure 206c of the first prism layer 206a and the air, and thus become a reflected light R2. And another portion of the incident light L2 is refracted at G₂. When the incident light L2 arrives the anti-reflective layer 23, the incident light L2 is refracted into the anti-reflective layer 23 at H₂, which is at the interface between the anti-reflective layer 23 and air, and is directly introduced into the second prism layer 206b. In other words, light reflected back to the first prism layer 206a at H₂ is substantially reduced while light refracted into the second prism layer 206b is increased. Therefore, reflective Moire or Newton ring occurred in the prior art due to interference between the reflected lights are avoided.

As mentioned above, the anti-reflective layer 23 provided by the first preferred embodiment is positioned between the first prism layer 206a and the second prism layer 206b for reducing light reflection and thus to avoid interference between the reflected lights. Furthermore, since the reflected light is reduced and the light refracted into second prism layer 206b is increased by the anti-reflective layer 23, light intensity of the light incident to the second prism layer 206b and illumination of the backlight module 20 are both improved.

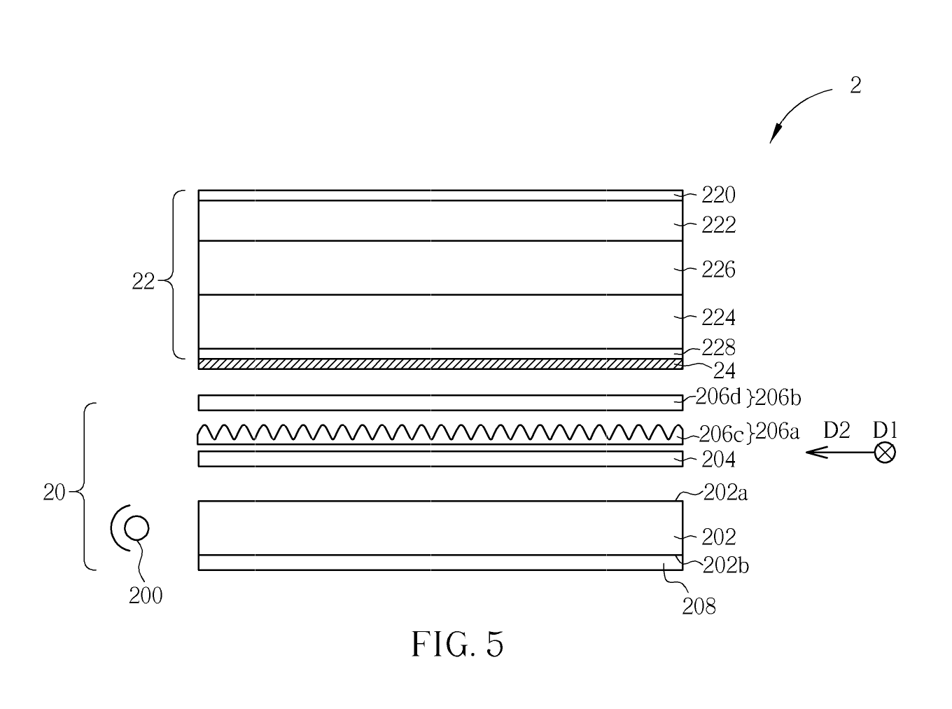

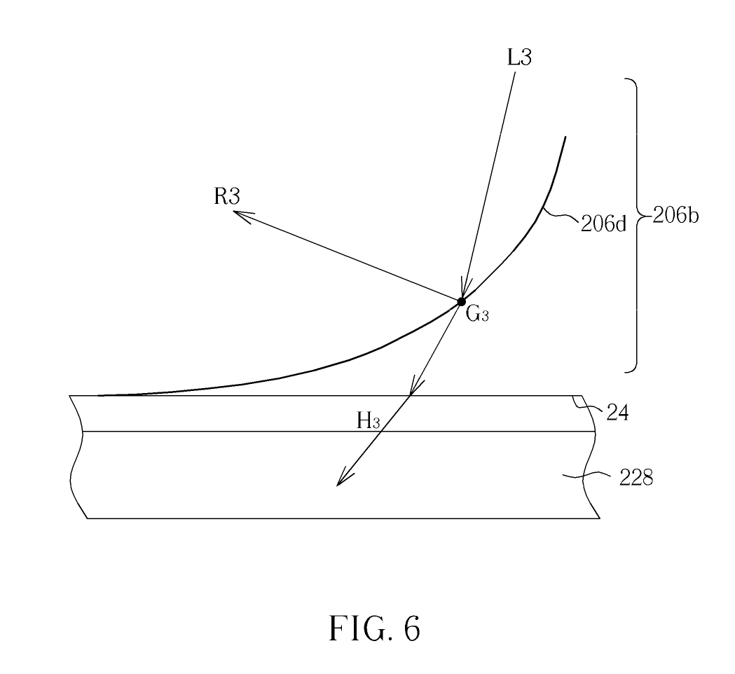

Please refer to FIG. 5 and FIG. 6, wherein FIG. 5 is a schematic drawing of a LCD device provided by a second preferred embodiment of the present invention, and FIG. 6 is a schematic drawing illustrating optical paths of the light according to the second preferred embodiment. It is noticeable that the same elements in the first and second preferred embodiment are designated by the same number, and its material choice and spatial relationship can be easily realize according to the description disclosed in the first preferred embodiment, therefore those details are omitted for the sake of simplicity. As shown in FIG. 5, different from the first preferred embodiment, by which the anti-reflective layer 23 is positioned between the first prism layer 206a and the second prism layer 206b, the second preferred embodiment provides an anti-reflective layer 24 positioned between the backlight module 20 and the LCD panel 22, more particularly, between the second prism layer 206b and the lower polarizer 228. Furthermore, the anti-reflective layer 24 is preferably an anti-reflective coating formed on the even light-incident surface of the lower polarizer 228.

Please refer to FIG. 6. When the light is emitted from the second prism layer 206b, a portion of the incident light L3 is reflected at G₃, which is at the interface between the prism structure 206d of the second prism layer 206b and the air, and thus become a reflective light R3. And another portion of the incident light L3 is refracted at G₃. When the incident light L3 arrives the anti-reflective layer 24, the incident light L3 is refracted into the anti-reflective layer 24 at H₃, which is at the interface between the anti-reflective layer 24 and the air, and is directly introduced into the lower polarizer 228. In other words, light reflected back to the second prism layer 206b at H₃ is substantially reduced and light refracted into the lower polarizer 228 is increased. Therefore, reflective Moire or Newton ring occurred in the prior art due to interference between the reflected lights are avoided.

As mentioned above, the anti-reflective layer 24 provided by the second preferred embodiment is positioned between the backlight module 20 and the LCD panel 22, more particularly between the second prism layer 206b of the backlight module 20 and the lower polarizer 228 of the LCD panel 22, for reducing light reflection and thus to avoid interference between the reflected lights. Furthermore, since the reflected light is reduced and the light refracted into the lower polarizer 228 is increased by the anti-reflective layer 24, light intensity of the light incident to the LCD panel 22 and illumination of the LCD device 2 are both improved.

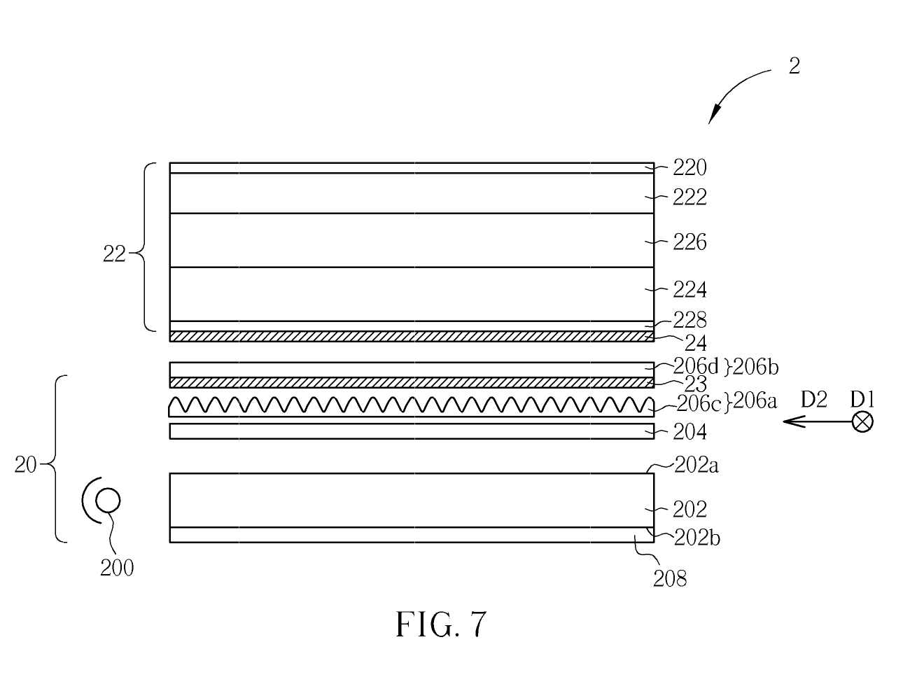

Please refer to FIG. 7, which is a schematic drawing of a LCD device provided by a third preferred embodiment of the present invention. It is noticeable that the same elements in the first, second and third preferred embodiment are designated by the same number, and its material choice and spatial relationship can be easily realize according to the description disclosed in the first preferred embodiment, therefore those details are omitted for the sake of simplicity. Different from the first and second preferred embodiment, the third preferred provides an anti-reflective layer (the second anti-reflective layer) 23 in the backlight module 20, more particularly between the first prism layer 206a and the second prism layer 206b, and another anti-reflective layer (the first anti-reflective layer) 24 between the backlight module 20 and the LCD panel 22, more particularly, between the second prism layer 206b of the backlight module 20 and the lower polarizer 228 of the LCD panel 22.

As mentioned above, the third preferred embodiment provides the anti-reflective layer 23 between the first prism layer 206a and the second prism layer 206b in the backlight module 20, and the anti-reflective layer 24 between the second prism layer 206b of the backlight module 20 and the lower polarizer 228 of the LCD panel 22 for reducing light reflection between the first prism layer 206a and the second prism layer 206b and between the second prism layer 206b and the lower polarizer 228, thus to avoid interference between the reflected lights. The optical paths of the third preferred embodiment are similar with those shown in FIG. 4 and FIG. 6, therefore the optical paths are omitted for the sake of simplicity.

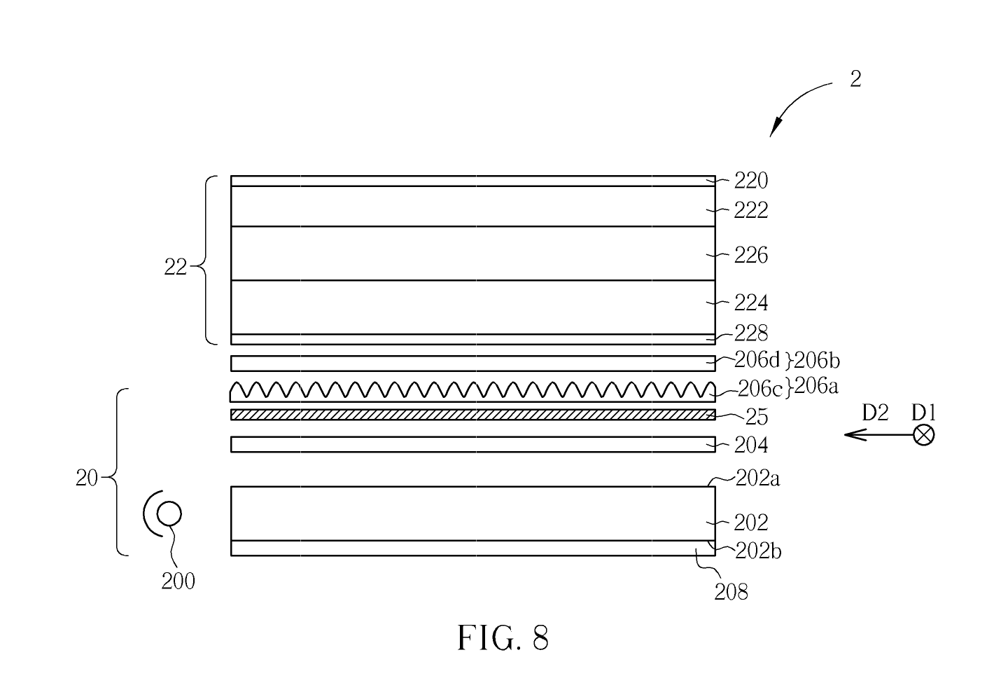

Please refer to FIG. 8, which is a schematic drawing of a LCD device provided by a fourth preferred embodiment of the present invention. It is noticeable that elements the same in the first, second, third and fourth preferred embodiment are designated by the same number, and its material choice and spatial relationship can be easily realize according to the description disclosed in the abovementioned preferred embodiments, therefore those details are omitted for the sake of simplicity. It is noteworthy that the interference such as Newton ring not only is occurred between the first prism layer 206a and the second prism layer 206b, between the second prism layer 206b and the lower polarizer 228, but also is occurred between the diffuser 204 and the first prism layer 206a. Therefore, the preferred embodiment provides an anti-reflective layer 25 between the diffuser 204 and the first prism layer 206a for reducing light reflection between the first prism layer 206a and the diffuser 204, and thus to avoid interference between the reflected lights. The optical paths of the third preferred embodiment are similar with those shown in FIG. 4 and FIG. 6, therefore the optical paths are omitted for the sake of simplicity.

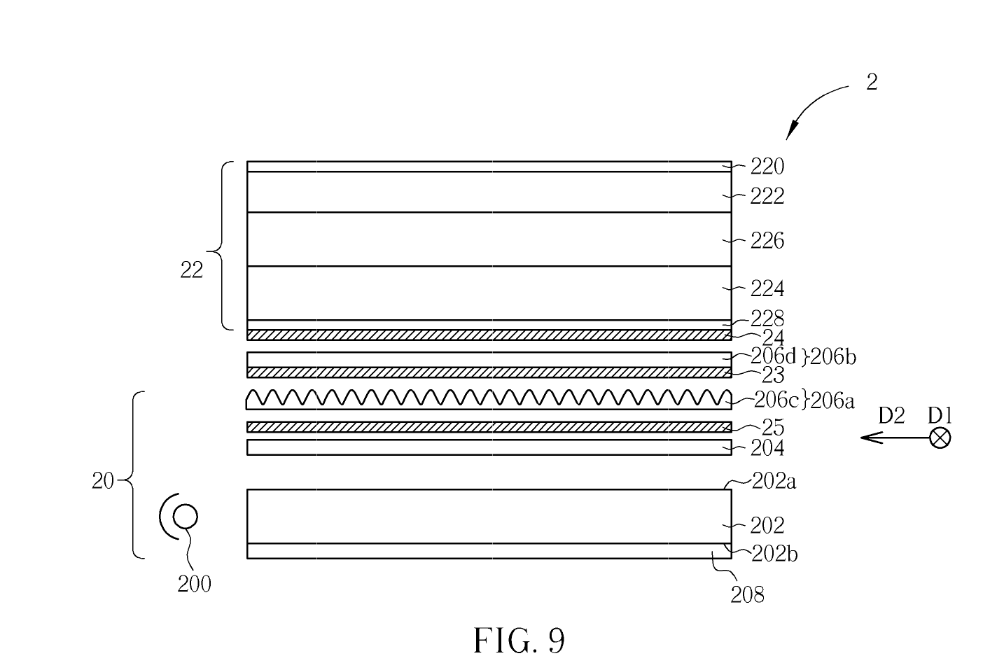

Please refer to FIG. 9, which is a schematic drawing of a LCD device provided by a fifth preferred embodiment of the present invention. It is noticeable that the same elements in the abovementioned preferred embodiment and the fifth preferred embodiment are designated by the same number, and its material choice and spatial relationship can be easily realize according to the description disclosed in the abovementioned preferred embodiments, therefore those details are omitted for the sake of simplicity. According to the fifth preferred embodiment. The LCD device includes the anti-reflective layer 23 positioned between the first prism layer 206a and the second prism layer 206b, the anti-reflective layer 24 positioned between the second prism layer 206b and the lower polarizer 228, and the anti-reflective layer 25 positioned between the first prism layer 206a and the diffuser 204 as shown in FIG. 9 for reducing light reflection between the abovementioned layers, and thus to avoid interference between the reflected lights.

According to the LCD device and the backlight module provided by the present invention, the anti-reflective layer is positioned between the prism layers or between the prism layer and an adjacent even surface. Therefore reflection between the prism layer and the adjacent even surface is reduced and consequently reflective Moire and Newton ring are avoided.

Those skilled in the art will readily observe that numerous modifications and alterations of the device and method may be made while retaining the teachings of the invention.

What is claimed is:

1. A backlight module comprising:
a light source providing lights;
a light guide plate having a light-emitting surface and a lower surface opposite to the light-emitting surface;
a first prism layer positioned on a side corresponding to the light-emitting surface of the light guide plate;
a second prism layer; and
an anti-reflective layer positioned between the first prism layer and the second prism layer.

2. The backlight module of claim 1, wherein the first prism layer comprises a plurality of first prism structures and the second prism layer comprises a plurality of second prism structures.

3. The backlight module of claim 2, wherein the first prism structures are arranged along a first direction and the second prism structures are arranged along a second direction.

4. A liquid crystal display (LCD) device comprises:
a LCD panel;
a backlight module comprising:
a light source for providing lights;
a light guide plate having a light-emitting surface and a lower surface opposite to the light-emitting surface; and
a first prism layer positioned on a side corresponding to the light-emitting surface of the light guide plate; and
a first anti-reflective layer positioned between the first prism layer and the LCD panel.

5. The LCD device of claim 4, wherein the LCD panel further comprising:
a color filter substrate;
a thin film transistor (TFT) array substrate;
an upper polarizer positioned on a surface of the color filter substrate opposite to the TFT array substrate; and
a lower polarizer positioned on a surface of the TFT array substrate opposite to the color filter substrate.

6. The LCD device of claim 5, wherein the first anti-reflective layer is positioned between the lower polarizer and the first prism layer.

7. The LCD device of claim 5, wherein the backlight module further comprises a second prism layer.

8. The LCD device of claim 7, wherein the second prism layer is positioned between the first anti-reflective layer and the lower polarizer.

9. The LCD device of claim 7, wherein the second prism layer is positioned between the first anti-reflective layer and the first prism layer.

10. The LCD device of claim 9, further comprising a second anti-reflective layer positioned between the first prism layer and the second prism layer.

11. The LCD device of claim 7, wherein the first prism layer comprises a plurality of first prism structures and the second prism layer comprises a plurality of second prism structures.

12. The LCD device of claim 11, wherein the first prism structures are arranged along a first direction and the second prism structures are arranged along a second direction.

13. The LCD device of claim 4, further comprising a diffuser positioned between the light guide plate and the first prism layer.

14. The LCD device of claim 13, further comprising a third anti-reflective layer positioned between the first prism layer and the diffuser.
